(19) United States
(12) Patent Application Publication
(10) Pub. No.: US 2014/0201322 A1
(43) Pub. Date: Jul. 17, 2014

(54) SERVER AND METHOD FOR TRANSMITTING VIDEOS

(71) Applicant: HON HAI PRECISION INDUSTRY CO., LTD., New Taipei (TW)

(72) Inventors: CHUNG-I LEE, New Taipei (TW); CHIEN-FA YEH, New Taipei (TW); CHIU-HUA LU, New Taipei (TW); YU-FENG CHIEN, New Taipei (TW); YA-CHIH CHANG, New Taipei (TW)

(73) Assignee: HON HAI PRECISION INDUSTRY CO., LTD., New Taipei (TW)

(21) Appl. No.: 14/141,493

(22) Filed: Dec. 27, 2013

(30) Foreign Application Priority Data
Jan. 14, 2013 (TW) 102101286

(51) Int. Cl. H04L 29/06

(52) U.S. Cl. CPC H04L 65/607
USPC 709/217

(57) ABSTRACT

In a method for transmitting videos from a server to a client device, a frame of one of the videos is captured, and a capture time of the frame is recorded into a storage device of the server. When the capturing time of the frame is greater than all of an encoding time, a transmitting time, and a decoding time of a previous frame, the frame is discarded. When the capture time of the frame is equal to or less than any of the encode time, the transmitting time, and the decoding time of the previous frame, the frame is encoded. The frame is then transmitted to the client device.

### BACKGROUND

1. Technical Field

Embodiments of the present disclosure relate to data transmission, and more particularly to a server and a method for transmitting videos.

2. Description of Related Art

Nowadays, terminal devices, such as computers, tablets, smart phones and TVs are widely used to watch online videos on the Internet. Unlike videos that are downloaded and played at any time in the future, streaming videos are played immediately after a small amount of video frames are received, and the video is not stored permanently in the terminal devices.

However, due to the encode rate of an online video server that generates and encodes video frames, network bandwidth, and the decode rate of the terminal devices, video qualities of the online videos may be poor. Therefore, there is room for improvement in the art.

### BRIEF DESCRIPTION OF THE DRAWINGS

FIG. 1 is a block diagram of one embodiment of a server comprising a video frame transmitting system.

FIG. 2 is a block diagram of one embodiment of function modules of the video frame transmitting system in FIG. 1.

FIG. 3 illustrates a flowchart of one embodiment of a method for transmitting videos.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.

In general, the word “module,” as used hereinafter, refers to logic embodied in hardware or firmware, or to a collection of software instructions, written in a programming language, such as, for example, Java, C, or Assembly. One or more software instructions in the modules may be embedded in firmware. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

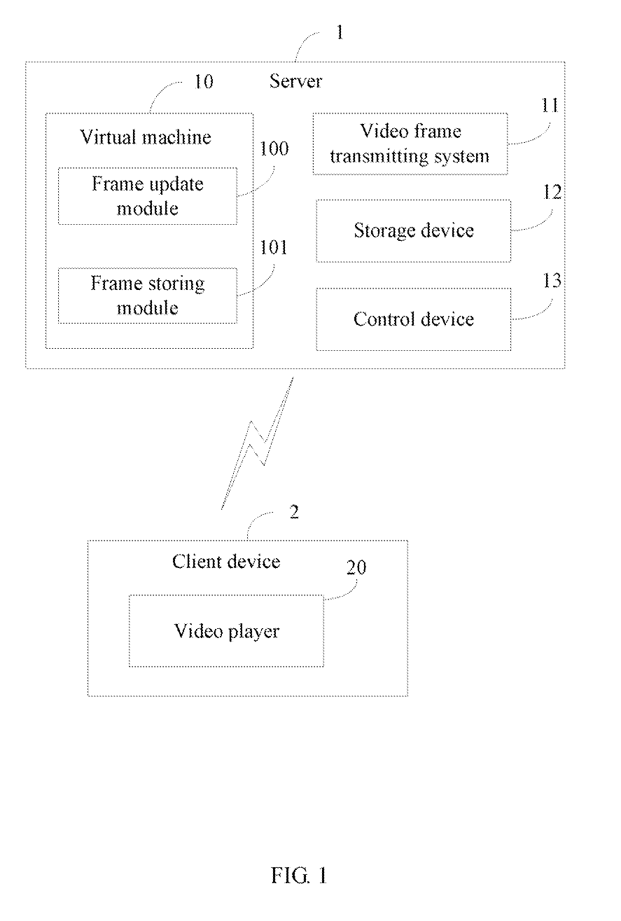

FIG. 1 is a block diagram of one embodiment of a server 1 including a video frame transmitting system 11. The server 1 is an online video server and is installed with a virtual machine (VM) 10 therein. The VM 10 comprises a frame update module 100 and a frame storing module 101. The frame update module 100 outputs a video and the frame storing module 101 stores each frame of the video into a storage space of the VM 10. The server 1 may further comprise components such as a storage device 12, and a control device 13. One skilled in the art would recognize that the server 1 may be configured in a number of other ways and may include other or different components.

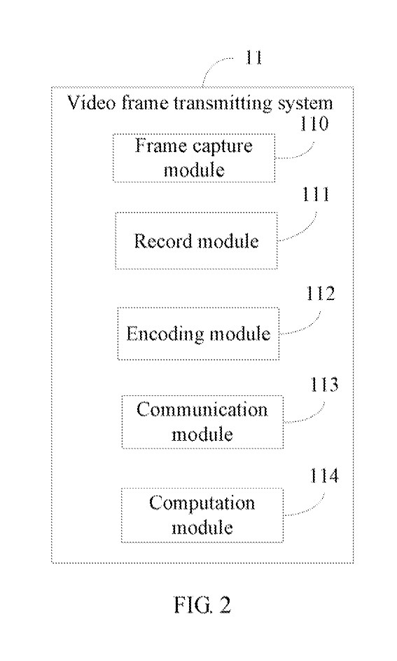

The video frame transmitting system 11 includes a number of function modules (depicted in FIG. 2). The function modules may include computerized codes in the form of one or more programs, which are stored in the storage device 12 and when is executed by the control device 13, to perform a function of encoding and transmitting the frames of the video to a client device 2 for decoding and playing the video by a video player 20 of the client device 2. In one embodiment, the client device 2 can communicate with the server 1 through a network including the Internet or a wireless network such as WIFI.

The storage device 12 comprises some type(s) of computer-readable storage medium, such as a hard disk drive, a compact disc, a digital video disc, or a tape drive.

The control device 13 may include a processor, a microprocessor, an application-specific integrated circuit (ASIC), and a field programmable gate array, (FPGA) for example.

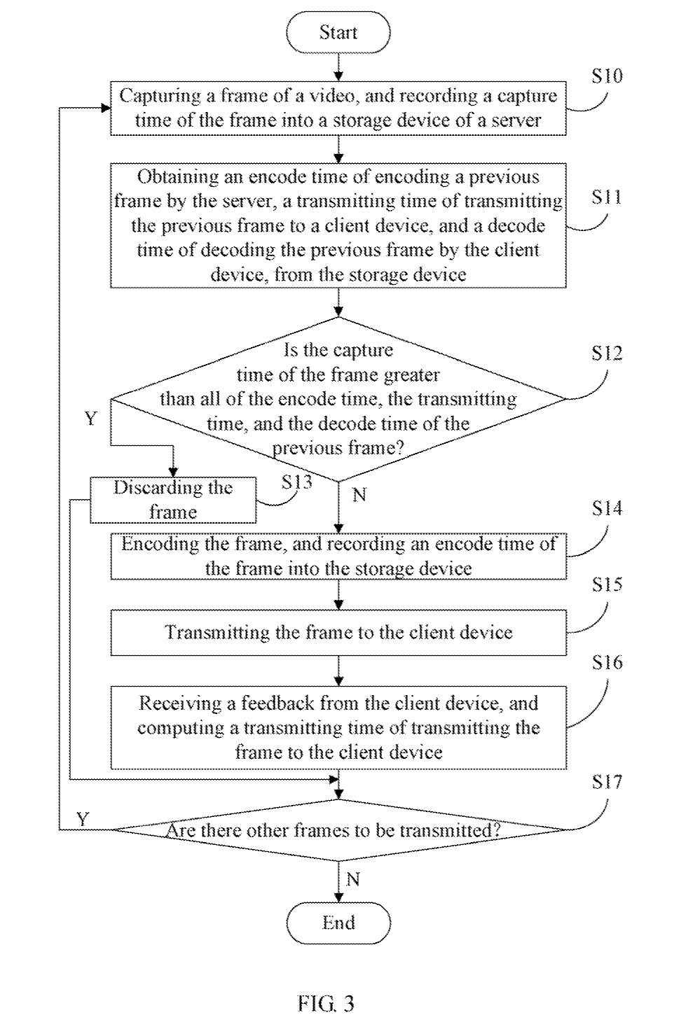

FIG. 2 is a block diagram of one embodiment of the function modules of the video frame transmitting system 11. In one embodiment, the video frame transmitting system 11 comprises a frame capture module 110, a record module 111, an encoding module 112, a communication module 113, and a computation module 114. The function modules 110-114 provide at least the functions needed to execute the steps illustrated in FIG. 3.

FIG. 3 illustrates a flowchart of one embodiment of a method for transmitting videos. Depending on the embodiment, additional steps in FIG. 3 may be added, others removed, and the ordering of the steps may be changed.

In step S10, the frame capture module 110 captures a frame of a video, and records a capture time of the frame into the storage device 12 of the server 1. As mentioned above, the frame update module 100 of the VM 10 outputs the video and the frame storing module 101 of the VM 10 stores each frame of the video into a storage space of the VM 10. The frame capture module 110 captures a frame of the video from the storage space of the VM 10, and records the capture time. In one embodiment, if the frame update module 100 of the VM 10 outputs a video 30 frames per second, namely FPS=30, then the capture time of a frame is 1/30 second.

In step S11, the record module 111 obtains an encode time of encoding a previous frame in the server 1, a transmitting time of transmitting the previous frame to the client device 2, and a decode time of decoding the previous frame by the client device 2, from the storage device 12. As described below, every time when the server 1 encodes a frame, transmits a frame to the client device 2, and the client device 2 decodes the frame, the encode time, the transmitting time, and the decode time of the frame are recorded in the storage device 12 of the server 1. It may be understood that, when there is no previous frame, the encode time, the transmitting time, and the decode time are all equal to zero.

In step S12, the encode module 112 determines if the capture time of the frame is greater than all of the encode time, the transmitting time, and the decode time of the previous frame. If the capture time of the frame is greater than all of the encode time, the transmitting time, and the decode time of the previous frame, step S13 is implemented. Otherwise, if the capture time of the frame is equal to or less than any of the encode time, the transmitting time, and the decode time of the previous frame, step S14 is implemented.

In step S13, the encode module 112 discards the frame when the capture time of the frame is greater than all of the encode time, the transmitting time, and the decode time of the previous frame. It may be understood that, discarding the frame means the encode module 112 does not encode and transmit the frame to the client device 2.

In step S14, the encode module 112 encodes the frame, and records an encode time of the frame into the storage device 12.

In step S15, the communication module 113 transmits the frame to the client device 2.

In step S16, the computation module 114 receives a feedback from the client device 2, and computes a transmitting time of transmitting the frame to the client device 2. The feedback comprises a decode time of decoding the frame by the client device 2 In one embodiment, the transmitting time of the frame is computed according to a time of transmitting the frame to the client device 2, a time of receiving the feedback from the client device 2 and the decode time of the frame in the client device 2. For example, when the communication module 113 transmits the frame to the client device 2 at 9:00, and receives the feedback from the client device 2 at 9:05, and a decode time of the frame in the client device 2 is 1 second, then the transmitting time of the frame is [(9:05−9:00)−1]/2, namely 2 seconds.

In step S17, the frame capture module 110 determines if there are other frames to be transmitted from the storage space of the VM 10. If there are other frames to be transmitted, the procedure goes back to step 10. If there is no frame to be transmitted, the procedure ends.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computerized method for transmitting videos, the method being executed by at least one processor of a server that outputs the videos, and the method comprising:
capturing a frame of one of the videos and record a capture time of the frame into a storage device of the server;
obtaining an encode time of encoding a previous frame in the server, a transmitting time of transmitting the previous frame to a client device, and a decode time of decoding the previous frame in the client device, from the storage device;
discarding the frame when the capture time of the frame is greater than all of the encode time, the transmitting time, and the decode time of the previous frame, and encoding the frame when the capture time of the frame is equal to or less than any of the encode time, the transmitting time, and the decode time of the previous frame;
recording an encode time of the frame into the storage device;
transmitting the frame to the client device, receiving a feedback from the client device, and computing a transmitting time of transmitting the frame to the client device, wherein the feedback comprises a decode time of decoding the frame by the client device; and
recording the decode time and the transmitting time of the frame into the storage device.

2. The method according to claim 1, wherein the server is installed with a virtual machine (VM) that comprises a frame update module that outputs the videos, and a frame storing module that stores each frame of the videos into a storage space of the VM.

3. The method according to claim 1, wherein the transmitting time of the frame is computed according to a time of transmitting the frame to the client device, a time of receiving the feedback from the client device and the decode time of the frame in the client device.

4. A server, comprising
a virtual machine (VM) that outputs videos;
a storage device;
at least one processor; and
one or more modules that are stored in the storage device, and are executed by the at least one processor, the one or more modules comprising instructions to:
capture a frame of one of the videos, and record a capture time of the frame into the storage device;
obtain an encode time of encoding a previous frame in the server, a transmitting time of transmitting the previous frame to a client device, and a decode time of decoding the previous frame in the client, from the storage device;
discarding the frame when the capture time of the frame is greater than all of the encode time, the transmitting time, and the decode time of the previous frame, and encode the frame when the capture time of the frame is equal to or less than any of the encode time, the transmitting time, and the decode time of the previous frame;
record an encode time of encoding the frame into the storage device;
transmit the frame to the client device, receive a feedback from the client device, compute a transmitting time of transmitting the frame to the client device, wherein the feedback comprises a decode time of decoding the frame by the client device; and
record the decode time and the transmitting time of the frame into the storage device.

5. The server according to claim 4, wherein the VM comprises:
a frame update module that outputs the videos; and
a frame storing module that stores each frame of the videos into a storage space of the VM.

6. The server according to claim 4, wherein the transmitting time of the frame is computed according to a time of transmitting the frame to the client device, a time of receiving the feedback from the client device and the decode time of the frame in the client device.

7. A non-transitory storage medium having stored thereon instructions that, when executed by a processor of a server that outputs videos, causes the processor to perform a method for transmitting videos, wherein the method comprises:
capturing a frame of one of the videos, and record a capture time of the frame into a storage device of the server;
obtaining an encode time of encoding a previous frame in the server, a transmitting time of transmitting the previous frame to a client device, and a decode time of decoding the previous frame in the client device, from the storage device;
discarding the frame when the capture time of the frame is greater than all of the encode time, the transmitting time, and the decode time of the previous frame, and encoding the frame when the capture time of the frame is equal to or less than any of the encode time, the transmitting time, and the decode time of the previous frame;
recording an encode time of the frame into the storage device;
transmitting the frame to the client device, receiving a feedback from the client device, and computing a transmitting time of transmitting the frame to the client device, wherein the feedback comprises a decode time of decoding the frame by the client device; and
recording the decode time of and the transmitting time of the frame into the storage device.

8. The non-transitory storage medium according to claim 7, wherein the server is installed with a virtual machine (VM) that comprises a frame update module that outputs the videos, and a frame storing module that stores each frame of the videos into a storage space of the VM.

9. The non-transitory storage medium according to claim 7, wherein the transmitting time of the frame is computed according to a time of transmitting the frame to the client device, a time of receiving the feedback from the client device and the decode time of the frame in the client device.
